(19) United States
(12) Patent Application Publication
(10) Pub. No.: US 2017/0159372 A1
(43) Pub. Date: Jun. 8, 2017

(54) RIG POSITIONING SYSTEM

(71) Applicant: Schlumberger Technology Corporation, Houston, TX (US)

(72) Inventors: Shunfeng Zheng, Katy, TX (US); Jacques Orban, Katy, TX (US)

(21) Appl. No.: 14/982,373

(22) Filed: Dec. 29, 2015

Related U.S. Application Data
(60) Provisional application No. 62/263,444, filed on Dec. 4, 2015.

(51) Int. Cl. E21B 15/00; G01S 13/02; G01S 19/13; E21B 33/03; H04B 10/40

(52) U.S. Cl. CPC E21B 15/003; E21B 33/03; H04B 10/40; G01S 19/13; G01S 13/02

(57) ABSTRACT

A rig positioning system includes a first position system having a first component that is coupled to a movable drilling rig so as to be movable therewith. The first position system detects a position of the movable drilling rig on a pad with respect to a well. The first position system has a first accuracy. A second position system has a first component coupled to the movable drilling rig so as to be movable therewith, and a second component. The movable drilling rig is movable with respect to the second component. The second position system determines the position of the movable drilling rig with respect to the well. The second position system has a second accuracy that is finer than the first accuracy.

### CROSS-REFERENCE TO RELATED APPLICATION

This application claims priority to U.S. Provisional Patent application having Ser. No. 62/263,444, filed on Dec. 4, 2015. The entirety of this priority provisional patent application is incorporated by reference herein.

### BACKGROUND

“Factory” drilling may involve drilling several wells in proximity to one another (e.g., on a “pad”), and moving the drilling rig between the wells, sometimes several times. For example, the rig may first drill a section (e.g. top section) of a well, then move to another location to drill the top section of another well, etc. Once the top sections of each well in the pad are drilled, the rig may drill the middle section of each well, again moving from one well to another until the middle sections are completed. The rig may then move on to drill the lower sections of each well, etc., until the wells are completed.

For pad drilling, rig positioning is a challenge because the (large) size of the rig makes the rig difficult to precisely position. If the rig is not aligned properly with a well whose upper section has been drilled, equipment and/or wellbore damage may occur when the equipment is employed, out of alignment, to drill the lower sections of the well.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

A rig positioning system is disclosed. The system includes a first position system having a first component that is coupled to a movable drilling rig so as to be movable therewith. The first position system detects a position of the movable drilling rig on a pad with respect to a well. The first position system has a first accuracy. A second position system has a first component coupled to the movable drilling rig so as to be movable therewith, and a second component. The movable drilling rig is movable with respect to the second component. The second position system determines the position of the movable drilling rig with respect to the well. The second position system has a second accuracy that is finer than the first accuracy.

A method for positioning a movable drilling rig on a pad is also disclosed. The method includes determining a rough position of the movable drilling rig with respect to a well using a first position system having a first component that is attached to the movable drilling rig. The first position system has a first accuracy. The movable drilling rig is moved based on the rough position, such that the first position system indicates that the movable drilling rig is aligned with the well. A fine position of the movable drilling rig is determined with respect to the well using a second position system having a first component that is attached to the movable drilling rig and a second component. The movable drilling rig is movable with respect to the second component. The second position system has a second accuracy that is finer than the first accuracy. The movable drilling rig is moved based on the fine position, such that the second position system indicates that the movable drilling rig is aligned with the well.

In another embodiment, the method includes determining a position of the movable drilling rig with respect to a first well during a first time period using a first position system. The first position system includes a first component that is attached to the movable drilling rig. The position of the movable drilling rig is determined with respect to the first well during the first time period using a second position system. The second position system is more accurate than the first position system. The second position system includes a first component that is attached to the movable drilling rig and a second component coupled to a wellhead or a blowout preventer. The movable drilling rig is moved away from the first well. The movable drilling rig is then moved back toward the first well after the movable drilling rig is moved away from the first well. The position of the movable drilling rig is determined with respect to the first well during a second time period using the first positioning system. The second time period is after the movable rig is moved back toward the first well. The movable drilling rig is moved based on the position of the movable drilling rig determined by the first position system during the second time period such that the first position system indicates that the movable drilling rig is aligned with the first well. The position of the movable drilling rig is determined with respect to the first well during the second time period using the second positioning system. The movable drilling rig is moved based on the position of the movable drilling rig determined by the second position system during the second time period such that the second position system indicates that the movable rig is aligned with the first well.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates a schematic view of a drilling rig and a control system, according to an embodiment.

FIG. 2 illustrates a schematic view of a drilling rig and a remote computing resource environment, according to an embodiment.

FIG. 3 illustrates a schematic view of a drilling rig positioning system, according to an embodiment.

FIG. 4 illustrates a schematic view of another drilling rig positioning system, according to an embodiment.

FIG. 5 illustrates a schematic view of another drilling rig positioning system, according to an embodiment.

FIG. 6 illustrates a schematic view of another drilling rig positioning system, according to an embodiment.

FIG. 7 illustrates a schematic view of another drilling rig positioning system, according to an embodiment.

FIG. 8 illustrates a flowchart of a method or positioning a movable rig on a pad, according to an embodiment.

FIG. 9 illustrates a schematic view of a computing system, according to an embodiment.

### DETAILED DESCRIPTION

Reference will now be made in detail to specific embodiments illustrated in the accompanying figures. In the following detailed description, numerous specific details are set forth in order to provide a thorough understanding of the present disclosure. However, it will be apparent to one of ordinary skill in the art that embodiments may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object could be termed a second object, and, similarly, a second object could be termed a first object, without departing from the scope of the present disclosure.

The terminology used in the description herein is for the purpose of describing particular embodiments only and is not intended to be limiting. As used in the description and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

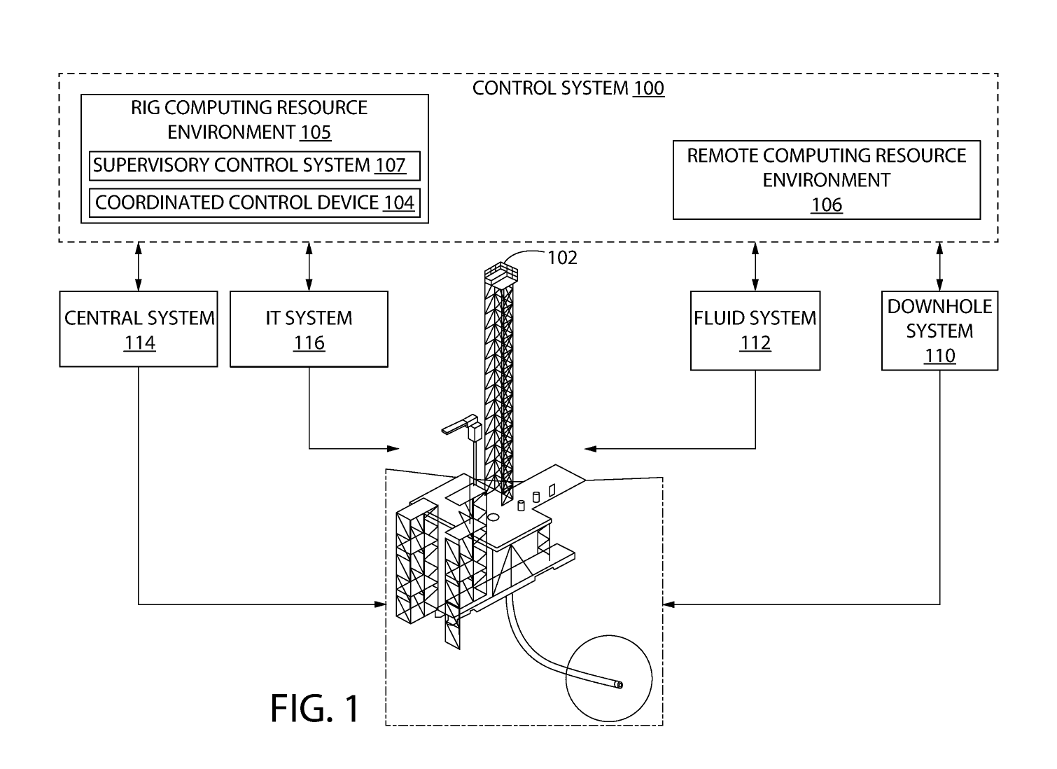

FIG. 1 illustrates a conceptual, schematic view of a control system 100 for a drilling rig 102, according to an embodiment. The control system 100 may include a rig computing resource environment 105, which may be located onsite at the drilling rig 102 and, in some embodiments, may have a coordinated control device 104. The control system 100 may also provide a supervisory control system 107. In some embodiments, the control system 100 may include a remote computing resource environment 106, which may be located offsite from the drilling rig 102.

The remote computing resource environment 106 may include computing resources locating offsite from the drilling rig 102 and accessible over a network. A “cloud” computing environment is one example of a remote computing resource. The cloud computing environment may communicate with the rig computing resource environment 105 via a network connection (e.g., a WAN or LAN connection). In some embodiments, the remote computing resource environment 106 may be at least partially located onsite, e.g., allowing control of various aspects of the drilling rig 102 onsite through the remote computing resource environment 105 (e.g., via mobile devices). Accordingly, “remote” should not be limited to any particular distance away from the drilling rig 102.

Further, the drilling rig 102 may include various systems with different sensors and equipment for performing operations of the drilling rig 102, and may be monitored and controlled via the control system 100, e.g., the rig computing resource environment 105. Additionally, the rig computing resource environment 105 may provide for secured access to rig data to facilitate onsite and offsite user devices monitoring the rig, sending control processes to the rig, and the like.

Various example systems of the drilling rig 102 are depicted in FIG. 1. For example, the drilling rig 102 may include a downhole system 110, a fluid system 112, and a central system 114. These systems 110, 112, 114 may also be examples of “subsystems” of the drilling rig 102, as described herein. In some embodiments, the drilling rig 102 may include an information technology (IT) system 116. The downhole system 110 may include, for example, a bottomhole assembly (BHA), mud motors, sensors, etc. disposed along the drill string, and/or other drilling equipment configured to be deployed into the wellbore. Accordingly, the downhole system 110 may refer to tools disposed in the wellbore, e.g., as part of the drill string used to drill the well.

The fluid system 112 may include, for example, drilling mud, pumps, valves, cement, mud-loading equipment, mud-management equipment, pressure-management equipment, separators, and other fluids equipment. Accordingly, the fluid system 112 may perform fluid operations of the drilling rig 102.

The central system 114 may include a hoisting and rotating platform, top drives, rotary tables, kellys, drawworks, pumps, generators, tubular handling equipment, derricks, masts, substructures, and other suitable equipment. Accordingly, the central system 114 may perform power generation, hoisting, and rotating operations of the drilling rig 102, and serve as a support platform for drilling equipment and staging ground for rig operation, such as connection make up, etc. The IT system 116 may include software, computers, and other IT equipment for implementing IT operations of the drilling rig 102.

The control system 100, e.g., via the coordinated control device 104 of the rig computing resource environment 105, may monitor sensors from multiple systems of the drilling rig 102 and provide control commands to multiple systems of the drilling rig 102, such that sensor data from multiple systems may be used to provide control commands to the different systems of the drilling rig 102. For example, the system 100 may collect temporally and depth aligned surface data and downhole data from the drilling rig 102 and store the collected data for access onsite at the drilling rig 102 or offsite via the rig computing resource environment 105. Thus, the system 100 may provide monitoring capability. Additionally, the control system 100 may include supervisory control via the supervisory control system 107.

In some embodiments, one or more of the downhole system 110, fluid system 112, and/or central system 114 may be manufactured and/or operated by different vendors. In such an embodiment, certain systems may not be capable of unified control (e.g., due to different protocols, restrictions on control permissions, safety concerns for different control systems, etc.). An embodiment of the control system 100 that is unified, may, however, provide control over the drilling rig 102 and its related systems (e.g., the downhole system 110, fluid system 112, and/or central system 114, etc.). Further, the downhole system 110 may include one or a plurality of downhole systems. Likewise, fluid system 112, and central system 114 may contain one or a plurality of fluid systems and central systems, respectively.

In addition, the coordinated control device 104 may interact with the user device(s) (e.g., human-machine interface(s)) 118, 120. For example, the coordinated control device 104 may receive commands from the user devices 118, 120 and may execute the commands using two or more of the rig systems 110, 112, 114, e.g., such that the operation of the two or more rig systems 110, 112, 114 act in concert and/or off-design conditions in the rig systems 110, 112, 114 may be avoided.

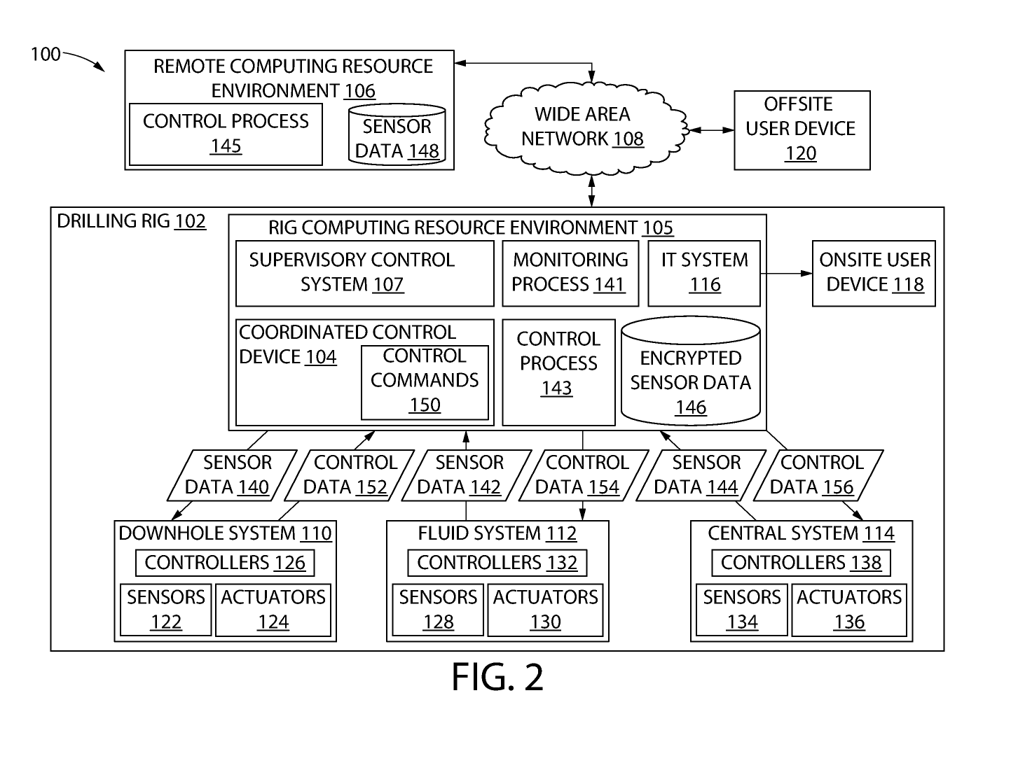

FIG. 2 illustrates a conceptual, schematic view of the control system 100, according to an embodiment. The rig computing resource environment 105 may communicate with offsite devices and systems using a network 108 (e.g., a wide area network (WAN) such as the internet). Further, the rig computing resource environment 105 may communicate with the remote computing resource environment 106 via the network 108. FIG. 2 also depicts the aforementioned example systems of the drilling rig 102, such as the downhole system 110, the fluid system 112, the central system 114, and the IT system 116. In some embodiments, one or more onsite user devices 118 may also be included on the drilling rig 102. The onsite user devices 118 may interact with the IT system 116. The onsite user devices 118 may include any number of user devices, for example, stationary user devices intended to be stationed at the drilling rig 102 and/or portable user devices. In some embodiments, the onsite user devices 118 may include a desktop, a laptop, a smartphone, a personal data assistant (PDA), a tablet component, a wearable computer, or other suitable devices. In some embodiments, the onsite user devices 118 may communicate with the rig computing resource environment 105 of the drilling rig 102, the remote computing resource environment 106, or both.

One or more offsite user devices 120 may also be included in the system 100. The offsite user devices 120 may include a desktop, a laptop, a smartphone, a personal data assistant (PDA), a tablet component, a wearable computer, or other suitable devices. The offsite user devices 120 may be configured to receive and/or transmit information (e.g., monitoring functionality) from and/or to the drilling rig 102 via communication with the rig computing resource environment 105. In some embodiments, the offsite user devices 120 may provide control processes for controlling operation of the various systems of the drilling rig 102. In some embodiments, the offsite user devices 120 may communicate with the remote computing resource environment 106 via the network 108.

The user devices 118 and/or 120 may be examples of a human-machine interface. These devices 118, 120 may allow feedback from the various rig subsystems to be displayed and allow commands to be entered by the user. In various embodiments, such human-machine interfaces may be onsite or offsite, or both.

The systems of the drilling rig 102 may include various sensors, actuators, and controllers (e.g., programmable logic controllers (PLCs)), which may provide feedback for use in the rig computing resource environment 105. For example, the downhole system 110 may include sensors 122, actuators 124, and controllers 126. The fluid system 112 may include sensors 128, actuators 130, and controllers 132. Additionally, the central system 114 may include sensors 134, actuators 136, and controllers 138. The sensors 122, 128, and 134 may include any suitable sensors for operation of the drilling rig 102. In some embodiments, the sensors 122, 128, and 134 may include a camera, a pressure sensor, a temperature sensor, a flow rate sensor, a vibration sensor, a current sensor, a voltage sensor, a resistance sensor, a gesture detection sensor or device, a voice actuated or recognition device or sensor, or other suitable sensors.

The sensors described above may provide sensor data feedback to the rig computing resource environment 105 (e.g., to the coordinated control device 104). For example, downhole system sensors 122 may provide sensor data 140, the fluid system sensors 128 may provide sensor data 142, and the central system sensors 134 may provide sensor data 144. The sensor data 140, 142, and 144 may include, for example, equipment operation status (e.g., on or off, up or down, set or release, etc.), drilling parameters (e.g., depth, hook load, torque, etc.), auxiliary parameters (e.g., vibration data of a pump) and other suitable data. In some embodiments, the acquired sensor data may include or be associated with a timestamp (e.g., a date, time or both) indicating when the sensor data was acquired. Further, the sensor data may be aligned with a depth or other drilling parameter.

Acquiring the sensor data into the coordinated control device 104 may facilitate measurement of the same physical properties at different locations of the drilling rig 102. In some embodiments, measurement of the same physical properties may be used for measurement redundancy to enable continued operation of the well. In yet another embodiment, measurements of the same physical properties at different locations may be used for detecting equipment conditions among different physical locations. In yet another embodiment, measurements of the same physical properties using different sensors may provide information about the relative quality of each measurement, resulting in a “higher” quality measurement being used for rig control, and process applications. The variation in measurements at different locations over time may be used to determine equipment performance, system performance, scheduled maintenance due dates, and the like. Furthermore, aggregating sensor data from each subsystem into a centralized environment may enhance drilling process and efficiency. For example, slip status (e.g., in or out) may be acquired from the sensors and provided to the rig computing resource environment 105, which may be used to define a rig state for automated control. In another example, acquisition of fluid samples may be measured by a sensor and related with bit depth and time measured by other sensors. Acquisition of data from a camera sensor may facilitate detection of arrival and/or installation of materials or equipment in the drilling rig 102. The time of arrival and/or installation of materials or equipment may be used to evaluate degradation of a material, scheduled maintenance of equipment, and other evaluations.

The coordinated control device 104 may facilitate control of individual systems (e.g., the central system 114, the downhole system, or fluid system 112, etc.) at the level of each individual system. For example, in the fluid system 112, sensor data 128 may be fed into the controller 132, which may respond to control the actuators 130. However, for control operations that involve multiple systems, the control may be coordinated through the coordinated control device 104. Examples of such coordinated control operations include the control of downhole pressure during tripping. The downhole pressure may be affected by both the fluid system 112 (e.g., pump rate and choke position) and the central system 114 (e.g. tripping speed). When it is desired to maintain certain downhole pressure during tripping, the coordinated control device 104 may be used to direct the appropriate control commands. Furthermore, for mode based controllers which employ complex computation to reach a control setpoint, which are typically not implemented in the subsystem PLC controllers due to complexity and high computing power demands, the coordinated control device 104 may provide the adequate computing environment for implementing these controllers.

In some embodiments, control of the various systems of the drilling rig 102 may be provided via a multi-tier (e.g., three-tier) control system that includes a first tier of the controllers 126, 132, and 138, a second tier of the coordinated control device 104, and a third tier of the supervisory control system 107. The first tier of the controllers may be responsible for safety critical control operation, or fast loop feedback control. The second tier of the controllers may be responsible for coordinated controls of multiple equipment or subsystems, and/or responsible for complex model based controllers. The third tier of the controllers may be responsible for high level task planning, such as to command the rig system to maintain certain bottom hole pressure. In other embodiments, coordinated control may be provided by one or more controllers of one or more of the drilling rig systems 110, 112, and 114 without the use of a coordinated control device 104. In such embodiments, the rig computing resource environment 105 may provide control processes directly to these controllers for coordinated control. For example, in some embodiments, the controllers 126 and the controllers 132 may be used for coordinated control of multiple systems of the drilling rig 102.

The sensor data 140, 142, and 144 may be received by the coordinated control device 104 and used for control of the drilling rig 102 and the drilling rig systems 110, 112, and 114. In some embodiments, the sensor data 140, 142, and 144 may be encrypted to produce encrypted sensor data 146. For example, in some embodiments, the rig computing resource environment 105 may encrypt sensor data from different types of sensors and systems to produce a set of encrypted sensor data 146. Thus, the encrypted sensor data 146 may not be viewable by unauthorized user devices (either offsite or onsite user device) if such devices gain access to one or more networks of the drilling rig 102. The sensor data 140, 142, 144 may include a timestamp and an aligned drilling parameter (e.g., depth) as discussed above. The encrypted sensor data 146 may be sent to the remote computing resource environment 106 via the network 108 and stored as encrypted sensor data 148.

The rig computing resource environment 105 may provide the encrypted sensor data 148 available for viewing and processing offsite, such as via offsite user devices 120. Access to the encrypted sensor data 148 may be restricted via access control implemented in the rig computing resource environment 105. In some embodiments, the encrypted sensor data 148 may be provided in real-time to offsite user devices 120 such that offsite personnel may view real-time status of the drilling rig 102 and provide feedback based on the real-time sensor data. For example, different portions of the encrypted sensor data 146 may be sent to offsite user devices 120. In some embodiments, encrypted sensor data may be decrypted by the rig computing resource environment 105 before transmission or decrypted on an offsite user device after encrypted sensor data is received.

The offsite user device 120 may include a client (e.g., a thin client) configured to display data received from the rig computing resource environment 105 and/or the remote computing resource environment 106. For example, multiple types of thin clients (e.g., devices with display capability and minimal processing capability) may be used for certain functions or for viewing various sensor data.

The rig computing resource environment 105 may include various computing resources used for monitoring and controlling operations such as one or more computers having a processor and a memory. For example, the coordinated control device 104 may include a computer having a processor and memory for processing sensor data, storing sensor data, and issuing control commands responsive to sensor data. As noted above, the coordinated control device 104 may control various operations of the various systems of the drilling rig 102 via analysis of sensor data from one or more drilling rig systems (e.g. 110, 112, 114) to enable coordinated control between each system of the drilling rig 102. The coordinated control device 104 may execute control commands 150 for control of the various systems of the drilling rig 102 (e.g., drilling rig systems 110, 112, 114). The coordinated control device 104 may send control data determined by the execution of the control commands 150 to one or more systems of the drilling rig 102. For example, control data 152 may be sent to the downhole system 110, control data 154 may be sent to the fluid system 112, and control data 154 may be sent to the central system 114. The control data may include, for example, operator commands (e.g., turn on or off a pump, switch on or off a valve, update a physical property setpoint, etc.). In some embodiments, the coordinated control device 104 may include a fast control loop that directly obtains sensor data 140, 142, and 144 and executes, for example, a control algorithm. In some embodiments, the coordinated control device 104 may include a slow control loop that obtains data via the rig computing resource environment 105 to generate control commands.

In some embodiments, the coordinated control device 104 may intermediate between the supervisory control system 107 and the controllers 126, 132, and 138 of the systems 110, 112, and 114. For example, in such embodiments, a supervisory control system 107 may be used to control systems of the drilling rig 102. The supervisory control system 107 may include, for example, devices for entering control commands to perform operations of systems of the drilling rig 102. In some embodiments, the coordinated control device 104 may receive commands from the supervisory control system 107, process the commands according to a rule (e.g., an algorithm based upon the laws of physics for drilling operations), and/or control processes received from the rig computing resource environment 105, and provides control data to one or more systems of the drilling rig 102. In some embodiments, the supervisory control system 107 may be provided by and/or controlled by a third party. In such embodiments, the coordinated control device 104 may coordinate control between discrete supervisory control systems and the systems 110, 112, and 114 while using control commands that may be optimized from the sensor data received from the systems 110 112, and 114 and analyzed via the rig computing resource environment 105.

The rig computing resource environment 105 may include a monitoring process 141 that may use sensor data to determine information about the drilling rig 102. For example, in some embodiments the monitoring process 141 may determine a drilling state, equipment health, system health, a maintenance schedule, or any combination thereof. Furthermore, the monitoring process 141 may monitor sensor data and determine the quality of one or a plurality of sensor data. In some embodiments, the rig computing resource environment 105 may include control processes 143 that may use the sensor data 146 to optimize drilling operations, such as, for example, the control of drilling equipment to improve drilling efficiency, equipment reliability, and the like. For example, in some embodiments the acquired sensor data may be used to derive a noise cancellation scheme to improve electromagnetic and mud pulse telemetry signal processing. The control processes 143 may be implemented via, for example, a control algorithm, a computer program, firmware, or other suitable hardware and/or software. In some embodiments, the remote computing resource environment 106 may include a control process 145 that may be provided to the rig computing resource environment 105.

The rig computing resource environment 105 may include various computing resources, such as, for example, a single computer or multiple computers. In some embodiments, the rig computing resource environment 105 may include a virtual computer system and a virtual database or other virtual structure for collected data. The virtual computer system and virtual database may include one or more resource interfaces (e.g., web interfaces) that enable the submission of application programming interface (API) calls to the various resources through a request. In addition, each of the resources may include one or more resource interfaces that enable the resources to access each other (e.g., to enable a virtual computer system of the computing resource environment to store data in or retrieve data from the database or other structure for collected data).

The virtual computer system may include a collection of computing resources configured to instantiate virtual machine instances. The virtual computing system and/or computers may provide a human-machine interface through which a user may interface with the virtual computer system via the offsite user device or, in some embodiments, the onsite user device. In some embodiments, other computer systems or computer system services may be utilized in the rig computing resource environment 105, such as a computer system or computer system service that provisions computing resources on dedicated or shared computers/servers and/or other physical devices. In some embodiments, the rig computing resource environment 105 may include a single server (in a discrete hardware component or as a virtual server) or multiple servers (e.g., web servers, application servers, or other servers). The servers may be, for example, computers arranged in any physical and/or virtual configuration

In some embodiments, the rig computing resource environment 105 may include a database that may be a collection of computing resources that run one or more data collections. Such data collections may be operated and managed by utilizing API calls. The data collections, such as sensor data, may be made available to other resources in the rig computing resource environment or to user devices (e.g., onsite user device 118 and/or offsite user device 120) accessing the rig computing resource environment 105. In some embodiments, the remote computing resource environment 106 may include similar computing resources to those described above, such as a single computer or multiple computers (in discrete hardware components or virtual computer systems).

Embodiments of the present disclosure may provide systems and methods for positioning a drilling rig. Examples of such embodiments may employ global positioning system (GPS) transceivers to position a rig. Accuracy of such GPS transceivers may be in the range of a few meters. This position may then be used to differentiate relative locations of different wells. Such information may be used to automate drilling software or acquisition system setup. It may also be used to monitor drilling activities in an area.

Further, embodiments of the present disclosure may make use of sensors on the drilling rig, the ground, the wellhead, or the blowout preventer (BOP). Through, for example, triangulation, the relative location of the rig to the wellhead may be precisely identified (e.g., with an error of a few millimeters or less). This information may be used to monitor rig movement (e.g., allowing for automating the rig moving process), facilitate aligning the rig with the wellhead, as well as automate drilling software or acquisition system setup.

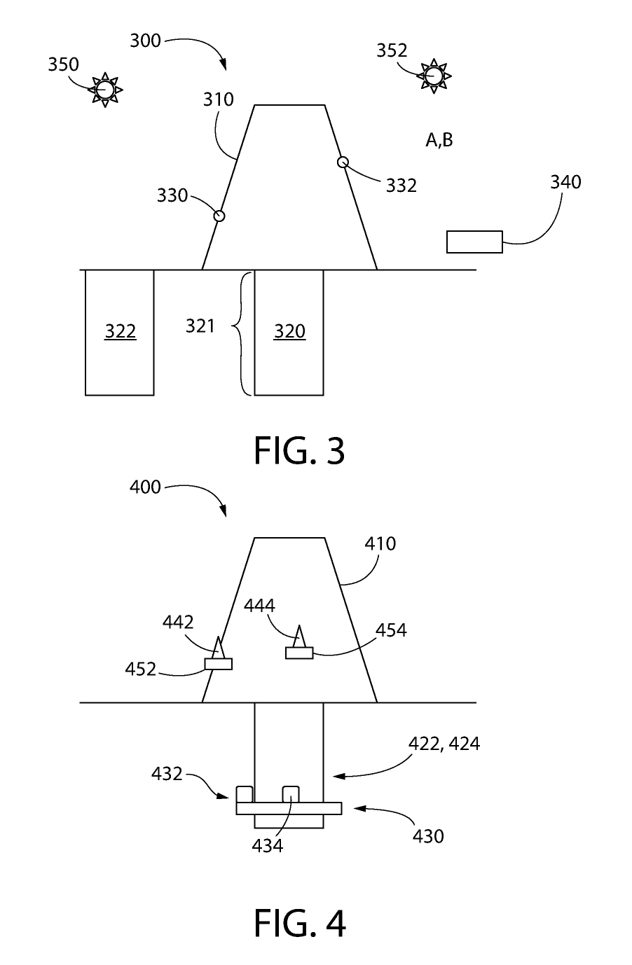

Turning now to the illustrated embodiments, FIG. 3 illustrates a schematic view of a drilling rig positioning system 300, according to an embodiment. The system 300 includes one or more GPS sensors (two are shown: 330, 332) on the rig 310. The position of the GPS sensors 330, 332 (and the rig 310) to which they are attached, may be determined using one or more satellites (two are shown: 350, 352). The GPS sensors 330, 332 may measure the elevation and/or horizontal position of the rig 310. In some embodiments, a single GPS sensor (e.g., sensor 330) may be installed at a (horizontal) position aligned with the center of the rig 310 or a straight line connecting the center of the top drive with the center of the well 320. In other embodiments, two or more GPS sensors (e.g., sensors 330, 332) may be placed there or elsewhere and employed to align the center of the rig 310 with the center of the well 320. When more than one GPS sensor 330, 332 is used, the GPS sensors 330, 332 may be used to position the center of rig 310 and also the azimuth of the main axis of the rig 310.

The accuracy of GPS sensors 330, 332 may be on the order of meters. With this accuracy, the positioning information may be used to locate the relative location of the well 320 in relation to other wells 322 within the pad, or it may be used to locate the pad position. This position information may be coupled with drilling software or acquisition software to automatically associate the acquisition data to a particular well (e.g., well 320), or pad.

With more advanced GPS technology (e.g. Real Time Kinematics), such as carrier-phase enhancement GPS (CPGPS), the accuracy may be enhanced to the order of millimeters. Systems with sub-meter accuracy may include a ground station 340. With this accuracy of millimeters, the GPS system may be employed to position the rig 310 for alignment with an existing well 320 whose upper section(s) 321 have been drilled.

FIG. 4 illustrates a schematic view of another drilling rig positioning system 400, according to an embodiment. In this embodiment, one or more optical reflectors (two are shown: 432, 434) may be installed around the wellsite. When a single reflector is used, the reflector may be positioned at the center of the well 420 or on a side of the well 420. As shown, two reflectors 432, 434 are installed on the wellhead 422 or the BOP 424. These optical reflectors 432, 434 may be installed in a fixed pattern on a flange 430, which may be bolted or otherwise connected to the wellhead 422 or the BOP 424. For example, the reflectors 432, 434 may be attached to different sides of the wellhead 422 or the BOP 424 such that the center of the well 420 is between the reflectors 432, 434. The optical reflectors 432, 434 may be removed from the flange 430 after each rig move. However, their relative positions with regard to the flange 430, and thus the wellhead 422 or BOP 424, may be fixed. In some embodiments, the reflectors 432, 434 may be installed back in place without a change in position relative to the wellhead 422 and/or the BOP 424. In some embodiments, the flange 430 may be omitted, and the optical reflectors 432, 434 may be installed directly on the wellhead 422 or the BOP 424.

One or more optical transceivers (two are shown: 442, 444) may be installed on the rig 410. The optical transceivers 442, 444 may be installed on different sides of the rig 410 (e.g., such that the center of the rig 410 is positioned between the optical transceivers 442, 444. The optical transceivers may measure distance. The measurement may be based on the time of flight of the pulse laser. Such devices may be laser theodolites. In another embodiment, the optical transceivers 442, 444 may measure rotational angle. The optical transceivers 442, 444 may be positioned within gimbals 452, 454 which may allow the transceivers 442, 444 to rotate with respect thereto. In operation, before the rig 410 moves from the well 420, the position and/or relative rotation angle of the transceivers 442, 444 may be recorded. When the rig 410 is moved back to the same well 420, one or more light signal(s) may be sent from the transceivers 442, 444 toward the reflectors 432, 434. The position of the rig 410 may be varied until the transceivers 442, 444 receive the reflection from the reflectors 432, 434. In some embodiments, the gimbal(s) 452, 454 may be rotated until the transceivers 442, 444 receive the reflection from the reflectors 432, 434.

When the center of the well 420 may be located, the rig 410 may be oriented around the well 420 to place the rig 410 back to its original position. More particularly, the center of the top drive may be above the well 420, and the main axis of the rig 410 may be parallel to, or substantially aligned with, its original position. To accomplish this, one or more additional optical receivers and/or optical transceivers may be used. The additional optical receiver(s) and/or optical transceiver(s) may be attached to any fixed reference point near the well 420. For example, the additional optical receiver(s) and/or optical transceiver(s) may be attached to another well, an element of a pit, a flare stack, etc.

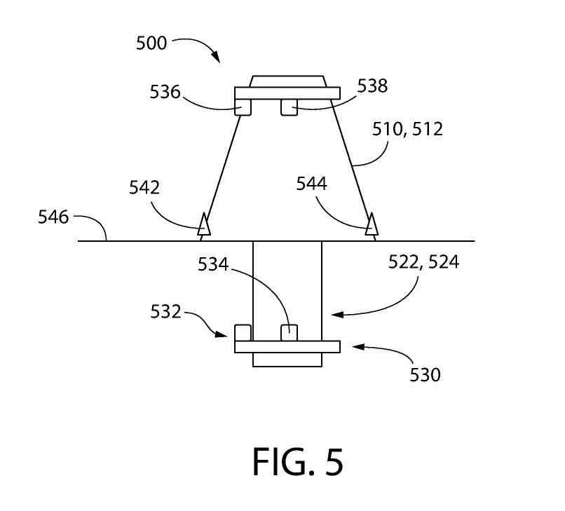

FIG. 5 illustrates a schematic view of another drilling rig positioning system 500, according to an embodiment. By placing one or more optical reflectors 536, 538 on the upper side of the mast 512 on the rig 510, the relative position of the mast 512 may be determined, and compared with the prior positioning of the mast 512 (e.g., prior to the previous move of the rig 510). The optical reflectors 436, 538 may be positioned such that the mast 512 is positioned between the optical reflectors 536, 538. In this embodiment, the optical transceivers 542, 544 may be attached to the rig floor structure 546. In another embodiment, transceivers 542, 544 may be installed on the wellhead 522 or the wellhead 524, and the reflectors 536, 538 may on installed in the rig 510.

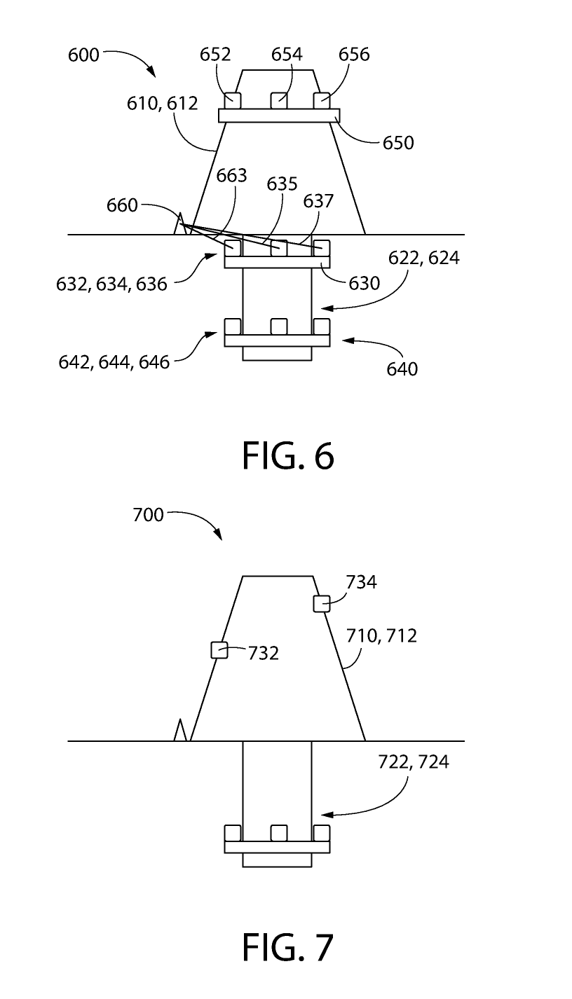

FIG. 6 illustrates a schematic view of another drilling rig positioning system 600, according to an embodiment. The center of the wellhead 622 or BOP 624 may be determined by measuring the distances 633, 635, 637 between a fixed location on the rig 610, and three discrete locations around the wellhead 622 or the BOP 624. With these three distances 633, 635, 637, and the relative position (or elevation) of the fixed location on the rig 610 to these discrete locations, the center of the wellhead 622 or the BOP 624 can be determined mathematically (e.g., using triangulation).

There are many different ways to measure the distance between two fixed points. In one embodiment, triangulation may be used for distance measurement. As shown in FIG. 6, a radar receiver 660 may be at the fixed location on the rig 610. A flange 630 may be installed on the wellhead 622 and/or the BOP 624. The flange 630 may equipped with a plurality of radar transmitters 632, 634, 636. In one embodiment, the transmitters 632, 634, 636 may be circumferentially-offset from one another around the flange 630. The relative elevation between the radar receiver 660 and the flange 630 may be known. Before each rig move, the radar transmitter 660 is turned on, and the distances 633, 635, 637 between the transmitters 632, 634, 636 and the receiver 660 may be determined. For example, the distances 633, 635, 637 may each be 5 meters. In another example, the first distance 633 may be 3 meters, the second distance 635 may be 4 meters, and the third distance 637 may be 5 meters. Using these distances, the center of the wellhead 622 or the BOP 624 may be determined, relative to the fixed location (e.g., the receiver 660) on the rig 610. When the rig 610 is being moved back to the well 620, the rig position of the rig 610 may be varied until the distances 633, 635, 637 match the original distances 633, 635, 637.

With the method of triangulation, multiple flanges 630, 640, 650, each having one or more radar transmitters may be installed at the different elevations of wellhead stacks (e.g., on the wellhead 622, the BOP 624, etc.) to help align the rig 610 with the center of wellhead 622 and/or BOP 624. As shown, the first flange 630 may have transmitters 632, 634, 636 coupled thereto. A second flange 640 may be positioned below the first flange 630 and have transmitters 642, 644, 646 coupled thereto. A third flange 650 may be positioned above the first flange 630 (e.g., coupled to the mast 612) and have transmitters 652, 654, 656 coupled thereto. Furthermore, by placing the radar transmitter(s) 652, 654, 656 on the mast 612 of the rig 610, triangulation may be employed to determine whether the mast 612 is aligned with the wellhead 622 and/or BOP 624, as a misalignment of the mast 612 relative to the wellhead 622 and/or BOP 624 may potentially damage drilling equipment. In another embodiment, a camera may be employed in addition to or instead of the radar receiver 660, and distinct visual features in place of the radar transmitter(s) 632, 634, 636, to conduct the triangulation method.

FIG. 7 illustrates a schematic view of another drilling rig positioning system 700, according to an embodiment. In this embodiment, one or more magnetometers 732, 734 are provided, to align the center of the rig 710 with the center of the well 720, and to align the mast 712 with the center of the well 720. The positioning of the rig 710 to the center of the well 720 may be based on the triangulation method described above. The one or more magnetometers 732, 734, installed on the rig 710 and/or mast 712, may measure the inclination of the mast 712. Alignment of the mast 712 to the center of the well 720 may be executed to make sure the inclination of the mast 712 is the same before and after the rig moves back to the same well 720, and to make sure the inclination of the mast 712 is maintained at a fixed angle (e.g., 0 degrees).

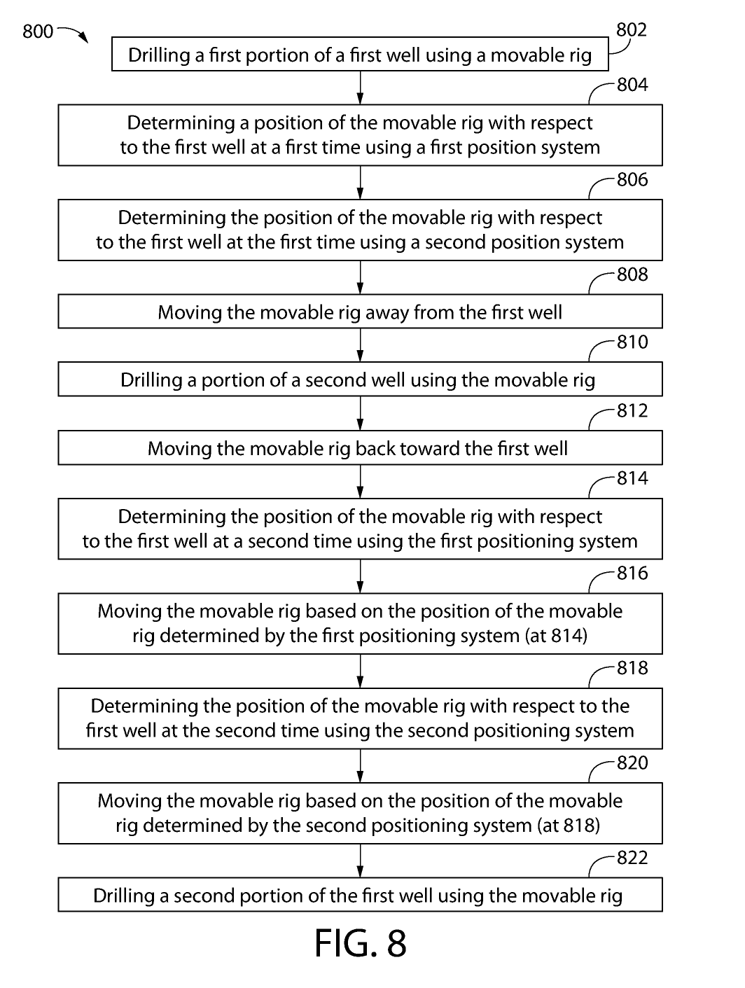

FIG. 8 illustrates a flowchart of a method 800 for positioning a movable rig on a pad, according to an embodiment. The method 800 may include drilling a first (e.g., upper) portion of a first well using a movable rig, as at 802. The method 800 may also include determining a position of the movable rig with respect to the first well during a first time period using a first position system, as at 804. The rig may be aligned with the well during the first time period. The first position system may include a first component that is attached to the movable rig. In at least one embodiment, the first component may be or include one or more of the GPS sensors 330, 332, as described above with respect to FIG. 3. The first position system may have a first (e.g., “rough”) accuracy. The data from the GPS sensors 330, 332 may be stored for usage when the rig is moved back to the first well at a later time.

The method 800 may also include determining the position of the movable rig with respect to the first well during the first time period using a second position system, as at 806. As used herein, the “first time period” includes a period of time that occurs before the moving at 806 below. Thus, the determining at 804 and the determining at 806 may or may not occur simultaneously. The second position system may include a first component that is attached to the movable rig. In at least one embodiment, the first component may be or include one or more of the GPS sensors 330, 332, as described above with respect to FIG. 3. In another embodiment, the first component may be or include one or more of the optical transceivers 442, 444, as described above with respect to FIG. 4. In yet another embodiment, the first component may be or include one or more of the reflectors 536, 538, as described above with respect to FIG. 5. In another embodiment, the first component may be or include one or more of the radar transmitters 652, 654, 656 and/or the radar receiver 660, as described above with respect to FIG. 6. In yet another embodiment, the first component may be or include one or more of the magnetometers 732, 734, as described above with respect to FIG. 7. The second position system may also include a second component, and the rig (and the first component) may be movable with respect to the second component. For example, the second component may be attached to the wellhead or the BOP. The second position system may have a second (e.g., “fine”) accuracy that is more accurate than the first accuracy. The second position system may store its sensor measurements, such as GPS data, sensor orientations, distance measurements, or angular measurements for usage when the rig is repositioned back to the first well at a later time.

The method 800 may then include moving the movable rig away from the first well (e.g., to align the movable rig with a second well on the pad), as at 808. The method 800 may then include drilling a portion of the second well using the movable rig, as at 810. The method 800 may then include moving the movable rig back toward the first well, as at 812.

The method 800 may then include determining the position of the movable rig with respect to the first well at during second time period using the first positioning system, as at 814. The method 800 may then include moving the movable rig based on the position of the movable rig determined by the first positioning system (at 814), as at 816. The movable rig may be moved until the first positioning system indicates that the movable rig is aligned with the first well. The first position system may use the sensor data acquired prior to the rig moving away from the first well to validate the movable rig is aligned with the first well.

The method 800 may then include determining the position of the movable rig with respect to the first well during the second time period using the second positioning system, as at 818. As used herein, the “second time period” includes a period of time that occurs after the moving at 808 and/or the drilling at 810 above. Thus, the determining at 814 and the determining at 818 do not have to occur simultaneously. In one embodiment, the determining at 814 may occur before the determining at 818. The method 800 may then include moving the movable rig based on the position of the movable rig determined by the second positioning system (at 818), as at 820. The movable rig may be moved until the second positioning system indicates that the movable rig is aligned with the first well. The second position system may use the sensor data acquired prior to the rig moving away from the first well to validate that the movable rig is aligned with the first well. The method 800 may then include drilling a second portion of the first well using the movable rig, as at 822.

Although described as determining and modifying a position of the movable rig above, in other embodiments, the method 800 may be used to determine and modify an inclination of the mast of the movable rig (e.g., to confirm that the inclination is the same before and after the movable rig is moved to the second well). For example, the method may include determining the inclination of the mast of the movable drilling rig at a first time when the movable drilling rig is aligned with the first well using a first position system. The first position system may include a first component that is attached to mast of the movable drilling rig. The first component of the first position system may be any of the components described above with reference to determining at 804 and/or determining at 806. The method may then include moving the movable drilling rig away from the first well and toward a second well. The method may then include moving the movable drilling rig back toward the first well after the movable drilling rig is moved toward the second well. The method may then include determining the inclination of the mast of the movable drilling rig at a second time when the movable drilling rig is aligned with the first well again using the first position system. The method may then include moving the mast such that the inclination of the mast at the second time matches the inclination of the mast at the first time.

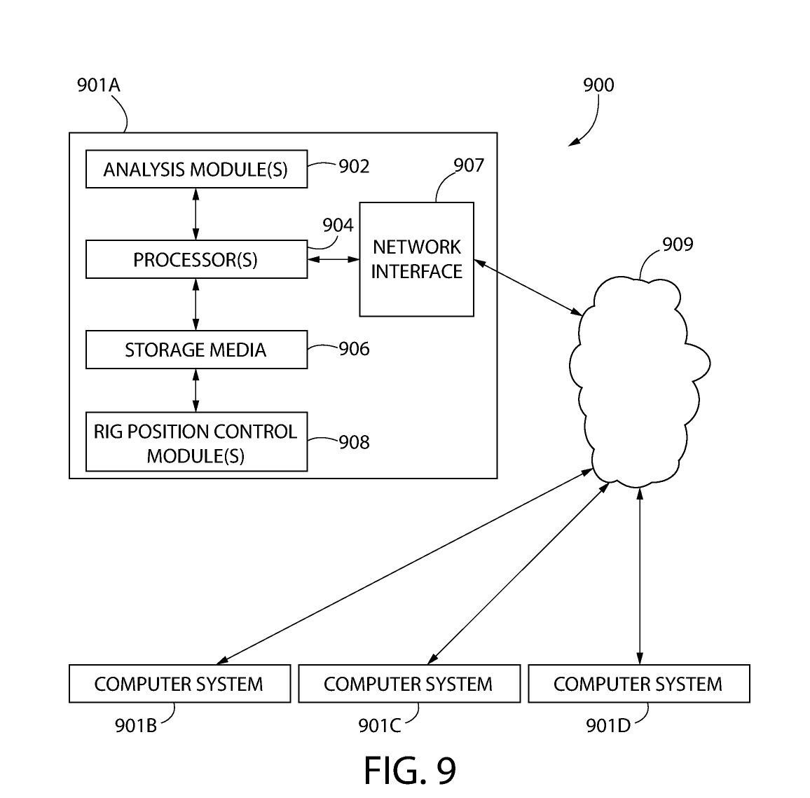

In some embodiments, the methods of the present disclosure may be executed by a computing system. FIG. 9 illustrates an example of such a computing system 900, in accordance with some embodiments. The computing system 900 may include a computer or computer system 901A, which may be an individual computer system 901A or an arrangement of distributed computer systems. The computer system 901A includes one or more analysis modules 902 that are configured to perform various tasks according to some embodiments, such as one or more methods disclosed herein. To perform these various tasks, the analysis module 902 executes independently, or in coordination with, one or more processors 904, which is (or are) connected to one or more storage media 906. The processor(s) 904 is (or are) also connected to a network interface 907 to allow the computer system 901A to communicate over a data network 909 with one or more additional computer systems and/or computing systems, such as 901B, 901C, and/or 901D (note that computer systems 901B, 901C and/or 901D may or may not share the same architecture as computer system 901A, and may be located in different physical locations, e.g., computer systems 901A and 901B may be located in a processing facility, while in communication with one or more computer systems such as 901C and/or 901D that are located in one or more data centers, and/or located in varying countries on different continents).

A processor may include a microprocessor, microcontroller, processor module or subsystem, programmable integrated circuit, programmable gate array, or another control or computing device.

The storage media 906 may be implemented as one or more computer-readable or machine-readable storage media. Note that while in the example embodiment of FIG. 9 storage media 906 is depicted as within computer system 901A, in some embodiments, storage media 906 may be distributed within and/or across multiple internal and/or external enclosures of computing system 901A and/or additional computing systems. Storage media 906 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURRY® disks, or other types of optical storage, or other types of storage devices. Note that the instructions discussed above may be provided on one computer-readable or machine-readable storage medium, or alternatively, may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, the computing system 900 contains one or more rig position control module(s) 908. In the example of computing system 900, computer system 901A includes the rig position control module 908. In some embodiments, a single rig position control module may be used to perform some or all aspects of one or more embodiments of the methods disclosed herein. In other embodiments, a plurality of rig position control modules may be used to perform at least some aspects of the methods herein.

It should be appreciated that computing system 900 is only one example of a computing system, and that computing system 900 may have more or fewer components than shown, may combine additional components not depicted in the example embodiment of FIG. 9, and/or computing system 900 may have a different configuration or arrangement of the components depicted in FIG. 9. The various components shown in FIG. 9 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of protection of the invention.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to explain at least some of the principals of the disclosure and their practical applications, to thereby enable others skilled in the art to utilize the disclosed methods and systems and various embodiments with various modifications as are suited to the particular use contemplated.

What is claimed is:

1. A rig positioning system, comprising:
a first component coupled to a movable drilling rig so as to be movable therewith; and
a second component, the movable drilling rig being movable with respect to the second component, and the rig positioning system being configured to determine a position of the movable drilling rig with respect to a well.

2. The rig positioning system of claim 1, wherein the first component comprises an optical transceiver configured to emit a beam of pulsed light.

3. The rig positioning system of claim 2, wherein the second component comprises an optical reflector coupled to a wellhead or a blowout preventer.

4. The rig positioning system of claim 3, wherein the optical reflector is used to determine a position of a center of the movable drilling rig and an azimuth of a main axis of the movable drilling rig.

5. The rig positioning system of claim 1, wherein the first component comprises a radar receiver, and wherein the second component comprises one or more radar transmitters coupled to a wellhead or a blowout preventer.

6. The rig positioning system of claim 1, wherein the first component comprises a magnetometer.

7. A rig positioning system, comprising:
a first position system having a first component that is coupled to a movable drilling rig so as to be movable therewith, the first position system being configured to detect a position of the movable drilling rig on a pad with respect to a well, wherein the first position system has a first accuracy; and
a second position system having a first component coupled to the movable drilling rig so as to be movable therewith, and a second component, the movable drilling rig being movable with respect to the second component, and the second position system being configured to determine the position of the movable drilling rig with respect to the well, wherein the second position system has a second accuracy that is finer than the first accuracy.

8. The rig positioning system of claim 7, wherein the first component of the first position system comprises a global positioning system (GPS) sensor.

9. The rig positioning system of claim 7, wherein the first component of the second position system comprises an optical transceiver.

10. The rig positioning system of claim 9, wherein the optical transceiver is configured to emit a beam of pulsed light.

11. The rig positioning system of claim 10, wherein the second component of the second position system comprises an optical reflector coupled to a wellhead or a blowout preventer.

12. The rig positioning system of claim 10, wherein the second component of the second position system comprises one or more optical reflectors, each of which is attached to a circumferentially offset side of the wellhead or the blowout preventer.

13. The rig positioning system of claim 12, wherein the one or more optical reflectors is used to determine a position of a center of the movable drilling rig and an azimuth of a main axis of the movable drilling rig.

14. The rig positioning system of claim 7, wherein the first component of the second position system comprises an optical reflector.

15. The rig positioning system of claim 7, wherein the first component of the second position system comprises a radar receiver.

16. The rig positioning system of claim 15, wherein the second component of the second position system comprises one or more radar transmitters coupled to a wellhead or a blowout preventer.

17. The rig positioning system of claim 16, wherein one or more radar transmitters comprise a plurality of radar transmitters that are circumferentially-offset from one another around the wellhead or the blowout preventer.

18. The rig positioning system of claim 7, wherein the first component of the second position system comprises a magnetometer.

19. The rig position system of claim 7, wherein the second position system comprises a global positioning system (GPS) system with a ground station

20. A rig positioning system, comprising:
a first global positioning system (GPS) configured to receive signals from one or more satellites to determine a position of a movable drilling rig with respect to a well, wherein the first GPS has a first accuracy; and
a second GPS configured to receive signals from a ground station to determine the position of the movable drilling rig with respect to the well, wherein the second GPS has a second accuracy that is finer than the first accuracy.

21. A method for positioning a movable drilling rig on a pad, comprising:
determining a rough position of the movable drilling rig with respect to a well using a first position system having a first component that is attached to the movable drilling rig, wherein the first position system has a first accuracy;
moving the movable drilling rig based on the rough position, such that the first position system indicates that the movable drilling rig is aligned with the well;
determining a fine position of the movable drilling rig with respect to the well using a second position system having a first component that is attached to the movable drilling rig and a second component, wherein the movable drilling rig is movable with respect to the second component, and wherein the second position system has a second accuracy that is finer than the first accuracy; and
moving the movable drilling rig based on the fine position, such that the second position system indicates that the movable drilling rig is aligned with the well.

22. The method of claim 21, wherein the first component of the first position system comprises a global positioning system (GPS) sensor.

23. The method of claim 21, wherein the first component of the second position system comprises an optical transceiver that is configured to emit a beam of pulsed light, and wherein the second component of the second position system comprises an optical reflector coupled to a wellhead or a blowout preventer that is configured to reflect the beam of pulsed light back to the optical transceiver.

24. The method of claim 23, wherein the second component of the second position system comprises at least two optical reflectors attached to different sides of the wellhead or the blowout preventer, wherein a center of the well is positioned between the at least two optical reflectors.

25. The method of claim 21, wherein the first component of the second position system comprises a radar receiver, and wherein the second component of the second position system comprises at least three radar transmitters coupled to a wellhead or a blowout preventer.

26. A method for positioning a movable drilling rig on a pad, comprising:
determining a position of the movable drilling rig with respect to a first well during a first time period using a first position system, wherein the first position system comprises a first component that is attached to the movable drilling rig;
determining the position of the movable drilling rig with respect to the first well during the first time period using a second position system, wherein the second position system is more accurate than the first position system, and wherein the second position system comprises:
a first component that is attached to the movable drilling rig;
a second component coupled to a wellhead or a blowout preventer;
moving the movable drilling rig away from the first well;
moving the movable drilling rig back toward the first well after the movable drilling rig is moved away from the first well;
determining the position of the movable drilling rig with respect to the first well during a second time period using the first positioning system, wherein the second time period is after the movable rig is moved back toward the first well;
moving the movable drilling rig based on the position of the movable drilling rig determined by the first position system during the second time period such that the first position system indicates that the movable drilling rig is aligned with the first well;
determining the position of the movable drilling rig with respect to the first well during the second time period using the second positioning system; and
moving the movable drilling rig based on the position of the movable drilling rig determined by the second position system during the second time period such that the second position system indicates that the movable rig is aligned with the first well.

27. The method of claim 26, further comprising drilling an upper portion of the first well before the movable drilling rig is moved away from the first well.

28. The method of claim 27, further comprising drilling a lower portion of the first well after the second position system indicates that the movable drilling rig is aligned with the first well.

29. The method of claim 28, further comprising drilling a portion of a second well after the movable drilling rig is moved away from the first well.

30. The method of claim 29, wherein the first component of the first position system comprises a global positioning system (GPS) sensor.

31. A method for measuring an inclination of a mast of a movable drilling rig, comprising:
determining the inclination of the mast of the movable drilling rig at a first time when the movable drilling rig is aligned with a first well using a first position system, wherein the first position system comprises a first component that is attached to mast of the movable drilling rig;
moving the movable drilling rig away from the first well and toward a second well;
moving the movable drilling rig back toward the first well after the movable drilling rig is moved toward the second well;
determining the inclination of the mast of the movable drilling rig at a second time when the movable drilling rig is aligned with the first well again using the first position system; and
moving the mast such that the inclination of the mast at the second time matches the inclination of the mast at the first time.
